(19) United States
(12) Patent Application Publication
(10) Pub. No.: US 2013/0268379 A1
(43) Pub. Date: Oct. 10, 2013

(54) METHOD AND APPARATUS FOR FRAUD AND RECONCILIATION CONTROL AT POINT OF SALE

(71) Applicant: BALANCE INNOVATIONS, LLC, Lenexa, KS (US)

(72) Inventors: Gilbert H. ANDERSON, Overland Park, KS (US); Todd F. SHUTTS, Prairie Village, KS (US); Kristina M. VAN ALLEN, Cincinnati, OH (US)

(73) Assignee: Balance Innovations, LLC, Lenexa, KS (US)

(21) Appl. No.: 13/859,542

(22) Filed: Apr. 9, 2013

Related U.S. Application Data
(60) Provisional application No. 61/621,796, filed on Apr. 9, 2012.

(51) Int. Cl. G06Q 20/20

(52) U.S. Cl. CPC G06Q 20/201
USPC 705/20

(57) ABSTRACT

Methods and apparatuses streamline transactions involving both a service provider application and a point of sale to control fraud and improve the reconciliation process. Transactions generated at a service provider application are communicated to the point of sale and are finalized at the point of sale to avoid dual entry, minimizing errors. Alerts are generated when outstanding service provider generated transactions are not finalized within a defined period of time.

### RELATED APPLICATIONS

The present U.S. non-provisional patent application is related to and claims priority benefit to an earlier-filed provisional patent application titled METHOD & APPARATUS FOR FRAUD & RECONCILIATION CONTROL IN POINT OF SALE SYSTEMS, Ser. No. 61/621,796, filed Apr. 9, 2012. The identified earlier-filed application is hereby incorporated by reference into the present application as though fully set forth herein.

### BACKGROUND

The present invention relates generally to methods and apparatuses to control fraud and reconciliation at a point of sale, and more particularly to methods and apparatuses for entering, receiving, storing, transmitting, selecting, retrieving, automatically mapping, matching, and tendering transactions.

A point of sale system used in conjunction with a service provider application provides opportunities for fraud and causes difficulties in reconciliation. In existing environments, vendors/service providers often provide retailers with free-standing terminals or other disparate systems (not connected with the retailer's own point of sale (“POS”) system or other general system) to perform certain transactions, such as wiring funds, selling lottery tickets, money orders, etc. A service provider application (e.g., a money transfer application) provided by the service provider (e.g., Western Union) may be either a web-based application or a physical device. A sales associate uses the service provider application to enter a transaction to sell a product or a service to a buyer. The sales associate also uses a point of sale to enter information regarding the transaction. The information entered into the point of sale duplicates some of the information entered into the service provider application. The dual entry of duplicative information increases the chances for errors and discrepancies, providing opportunities for fraud and causing difficulties in reconciliation.

Reconciliation of service provider transactions in existing environments requires a manual comparison of service provider reports to POS-generated reports at the end of the day. Discrepancies are often discovered outside the window of time when they can be easily resolved. Transactions that occur both before and after the POS end-of-day may result in reconciliation issues. Reconciliation reports often lack detail and are not centralized for easy corporate access and monitoring. Product codes from the terminals and corresponding POS price look up codes (PLU) are mapped and managed manually. Transactions may require a duplicate manual input—the sales associate may be required to enter the transaction both on the terminal application and again on the POS—allowing for mistakes and discrepancies between the two.

### SUMMARY

According to one embodiment, a method for fraud and reconciliation in a point of sale system is provided, the method comprising receiving information regarding a transaction, retrieving a PLU for the transaction information, creating a suspended point of sale transaction based on the transaction information, and determining the status of the suspended transaction.

In another embodiment, the method further comprises communicating the status of the suspended transaction to a user. In some embodiments, the method further comprises generating transaction information at a service provider application, transmitting the transaction information to a transaction broker having a memory, and storing the transaction information in the broker's memory.

According to an embodiment, the method further comprises transmitting the transaction information and the PLU to a point of sale gateway having a memory, storing the transaction and the PLU in the gateway's memory, and storing the suspended transaction. In another embodiment, the method further comprises retrieving the suspended transaction, presenting the suspended transaction at a point of sale terminal, processing the suspended transaction, and transmitting the suspended transaction information to a transaction broker.

In one aspect, the method further comprises transmitting the suspended transaction information to a reconciliation application, wherein the reconciliation application is configured to determine the status of the suspended transaction, present the status of the suspended transaction, and communicate the status of the suspended transaction to a user application. The status of the suspended transaction may be a completed transaction or a uncompleted transaction. The user application may be a point of sale software, a point of sale terminal, a messaging software, a display monitor, a wireless device, a mobile device, a communication software, a mobile phone, a smartphone, a pager, an e-mail service, an e-mail client, a device that generates sound, a device that generates light, or a device that generates mechanical movement. In one embodiment, the reconciliation application is further configured to communicate the status of the suspended transaction only when it is an uncompleted transaction.

In some embodiments, the method further comprises storing the suspended transaction, retrieving the suspended transaction, presenting the suspended at a point of sale terminal, processing the suspended transaction, and transmitting the status of the suspended transaction to a transaction broker.

According to another embodiment, a method for fraud and reconciliation control in a point of sale system is provided, the method comprising receiving information regarding a transaction from a service provider application, storing the transaction information, retrieving a PLU from a database for the transaction, creating a point of sale transaction comprising the transaction information, the PLU, and a retrieval number, the point of sale transaction having a status of uncompleted, and presenting the point of sale transaction at a point of sale terminal.

In one aspect, the method further comprises storing the point of sale transaction in the a memory of a point of sale server, the server having a sale transaction log, retrieving the point of sale transaction from the server's memory by the point of sale terminal, processing the point of sale transaction at the point of sale terminal, updating the status of point of sale transaction to completed, monitoring point of sale transactions to identify a completed point of sale transaction, and presenting the status of the point of sale transaction.

In one example, the method further comprises transmitting the transaction information and the PLU to a point of sale gateway, monitoring point of sale transactions to identify a completed point of sale transaction, notifying a transaction broker of the completed point of sale transaction, and presenting the status of a point of sale transaction.

In another example, the method further comprises completing the point of sales transaction at the point of sale terminal; updating the status of the point of sale transaction to completed; and providing a reconciliation application configured to retrieve the status of the point of sale transaction, present the status of the point of sale transaction; and communicate the status of the point of sale transaction to a user application. The user application may be a point of sale software, a point of sale terminal, a messaging software, a display monitor, a wireless device, a mobile device, a communication software, a mobile phone, a smartphone, a pager, an e-mail service, an e-mail client, a device that generates sound, a device that generates light, and a device that generates mechanical movement.

According to one embodiment, an apparatus for fraud and reconciliation control in a point of sale system is provided, the apparatus comprising a processor, a memory in communication with the processor, wherein the processor is configured to receive information regarding a transaction, receive information regarding completed transactions, generate an alert when the transaction information does not match any completed transactions. The alert may be a message to a software, a message to a mobile device, a message to a wireless device, a message to a telephone, an electronic mail, a sound, a visual stimulus, and a mechanical stimulus.

In one aspect, the processor of the apparatus is further configured to store the transaction information in the memory, retrieve a PLU for the transaction information, create a suspended point of sale transaction based on the transaction information and the PLU, monitor point of sale transactions for completed transactions, and post a completed transaction to the transaction log.

In one embodiment, the apparatus further comprises a service provider application for generating the transaction, wherein the information regarding the transaction is generated at the service provider application, the transaction information is received from the service provider application, and the processor is further configured to transmit information regarding the suspended transaction to the service provider application.

According to one aspect, the apparatus further comprises a point of sale terminal, wherein the suspended transaction information comprises a retrieval number corresponding to the suspended transaction, and the point of sale terminal is configured to retrieve the suspended transaction based on the retrieval number.

In another embodiment, the apparatus further comprises a reconciliation application, wherein the processor is further configured to store the transaction information and the completed transactions information; and the reconciliation application is configured to retrieve the transaction information and the completed transactions information and to generate the alert. In one embodiment, the alert is generated if the transaction information does not match any completed transactions after a defined period of time has elapsed.

In an aspect, the reconciliation application of the apparatus is further configured to match the transaction information with the completed transactions information and to generate a reconciliation report, the report including the information of each transaction and the information of the completed transactions.

According to one embodiment, an apparatus for fraud and reconciliation control in a point of sale system, the apparatus comprising at least one processor, at least one memory in communication with each processor, a transaction broker, a point of sale gateway, a point of sale terminal, and reconciliation application. The transaction broker is configured to receive, from a service provider application, information regarding a transaction; store the transaction information; retrieve a PLU for the transaction information; transmit the transaction information and the PLU to the point of sale gateway; transmit the transaction information and the PLU to a reconciliation application; receive information regarding a suspended transaction from the point of sale gateway; transmit the suspended transaction information to the service provider application; receive information regarding a completed transaction from the point of sale gateway; transmit the completed transaction information to the reconciliation application; transmit an indication of a store close record to the service provider application; and transmit the store close record indication to the reconciliation application.

The point of sale gateway is configured to receive the transaction information and the PLU from the broker; create a suspended point of sale transaction based on the transaction information and the PLU, the suspended transaction information including a retrieval number; transmit information regarding the suspended transaction to the broker; store the suspended transaction; monitor the point of sale transactions for completed transactions; monitor the point of sale transactions for the store close record indication; transmit information regarding completed transactions to the transaction broker; and transmit the store close record indication to the broker.

The point of sale terminal is configured to retrieve the suspended point of sale transaction and to post a completed transaction to the transaction log, where the reconciliation application is configured to: receive transaction information and completed transaction information from a broker; match transaction information with completed transactions; generate an alert for each transaction information that; after a defined period of time, does not have a matching completed transaction; and generate a reconciliation report comprising each transaction information and each completed transaction.

According to an aspect, the apparatus further comprises a plurality of service provider applications; a plurality of transaction brokers; and a plurality of point of sale gateways.

### BRIEF DESCRIPTION OF THE DRAWINGS

The drawings constitute a part of this specification and include exemplary embodiments of the disclosed subject matter and illustrate various objects and features thereof.

FIG. 1 is one embodiment of the apparatus of the disclosed subject matter.

FIG. 2 is one embodiment of the method of the disclosed subject matter.

FIG. 3 is one embodiment of the method of the disclosed subject matter.

### DETAILED DESCRIPTION

It is desirable to provide a solution that streamlines the workflow for working with a service provider application in conjunction with a point of sale. The solution provides alerts for outstanding transactions within a defined period of time to permit resolution of discrepancies between transactions entered at the service provider application and those entered at the point of sale. The solution includes centralized PLU management across service providers, and provide automated mapping of service provider product codes to PLUs.

Aspects of the method and apparatus provide an interface between the service provider application, whether a stand-alone terminal or a web application, and the POS or other general system. Alerts for transactions not completed with a defined period of time allow for tighter controls on fraud and on reconciliation processes. End-of-day communications permit synchronized reporting, reconciliation and balancing capabilities, which give the retailer the ability to resolve transactions that have not been completed prior to end-of-day reconciliation and POS close. Reports based on information from the service provider application and the POS system together are generated in one application, eliminating the need to compare reports from multiple sources. Manual data entry to match the service provider application's product codes with the POS PLUs is eliminated. Support for multiple vendors' terminals and multiple transaction types is provided. Finally, manual errors are minimized through the ability to suspend a transaction on the vendors' terminals and finalize it on the POS register by means of a retrieval number, as well as other methods and apparatuses to transfer the transaction and reconcile it to the POS system, so that both are in balance.

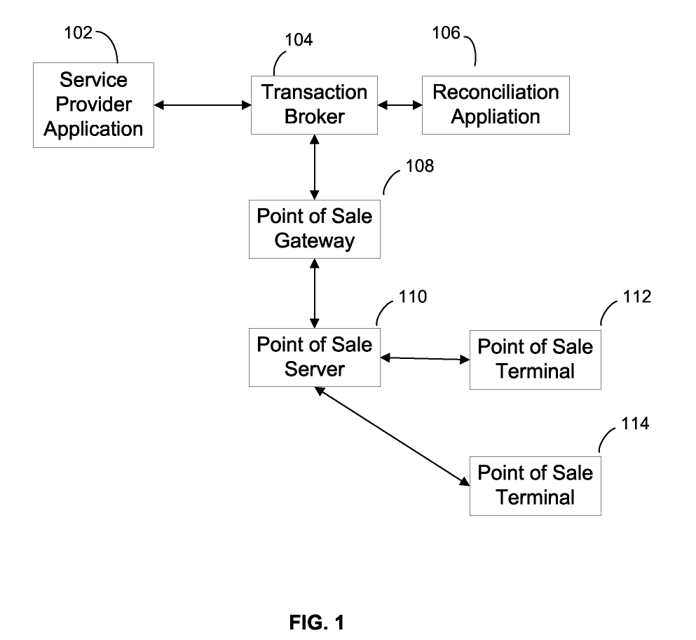

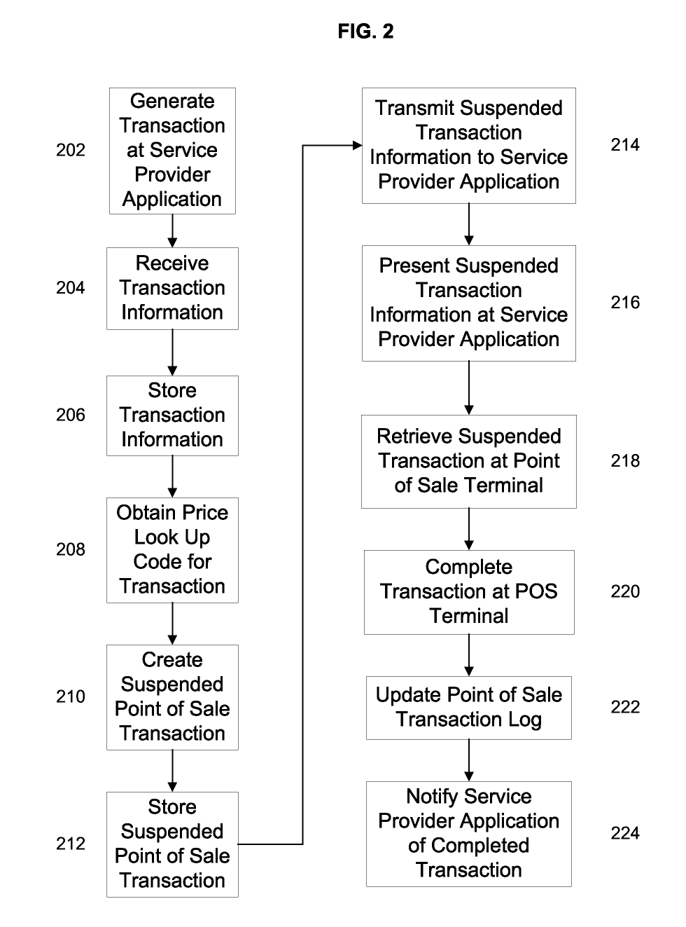

In an embodiment, a method and an apparatus are provided for receiving information 204 regarding a transaction generated at a service provider application 202 by a point of sale gateway 108. FIGS. 1 and 2. The service provider transaction may be a money transfer, money order, lottery ticket, etc. In addition to the POS gateway receiving the transaction information, a transaction broker 104, a point of sale server 110, or a point of sale terminal 112, 114 may also receive the transaction information. In one embodiment, the transaction information is received by the transaction broker 104, which in turn, transmits it to the POS gateway 108. In some instances, the POS gateway 108 may further transmit the transaction information to the POS server 110. The POS server 110 receives the transaction information, and may transmit the transaction information to a POS terminal 112,114. The server 110 may transmit the transaction information to a POS terminal 112,114, in response to a retrieval request by the terminal 112,114. In an embodiment, the transaction information is stored 206 in a memory or database.

In one embodiment, a PLU that corresponds to the product code in the transaction information is obtained 208. In one example, the POS gateway 108 obtains the PLU from a database or from a transaction broker 104. In some examples, the database may reside on the POS server 110, the transaction broker 104, or a reconciliation application 106. In another embodiment, the transaction broker 104 obtains the PLU from a database.

According to an embodiment, a suspended point of sale transaction is created based on the transaction information 210 and the suspended transaction is stored 212. In one example, a POS gateway 108 creates the suspended transaction based on the transaction information. The suspended transaction may include both the transaction information and the corresponding PLU. In one example, the suspended transaction is stored 212. For example, the POS gateway 108 may store the suspended transaction in its memory, in a memory of a POS server 110, or in a database.

In one aspect, information regarding the suspended transaction is transmitted 214 and stored 212, a retrieval number is presented 216, and the suspended transaction is retrieved 218. According to an embodiment, the POS gateway 108 transmits the suspended transaction information 214 to the service provider application 102. The suspended transaction information may include a retrieval number corresponding to the suspended transaction. In another embodiment, the POS gateway 108 transmits the suspended transaction information to a transaction broker 104, and the broker stores 212 the suspended transaction information in a memory or database. The transaction broker 104 may further transmit the suspended transaction information to the service provider application 102, 214. In an example, when the service provider application 102 receives the suspended transaction information, the application presents the retrieval number electronically or by paper, such as a transaction receipt 216. In another example, the previously stored suspended transaction is retrieved. For example, using the retrieval number to identify the stored suspended transaction, a sales associate may retrieve the suspended transaction at a POS terminal 218 without having to enter the transaction anew or to enter information that may be duplicative of the transaction information.

In one embodiment, a completed transaction is posted to the POS transaction log. As an example, after a suspended transaction is retrieved at a POS terminal 112,114, 218, the sales associate may complete the transaction 220, causing a completed transaction to be posted to the POS transaction log 222. In one example, completion of the transaction may be communicated to the service provider application.

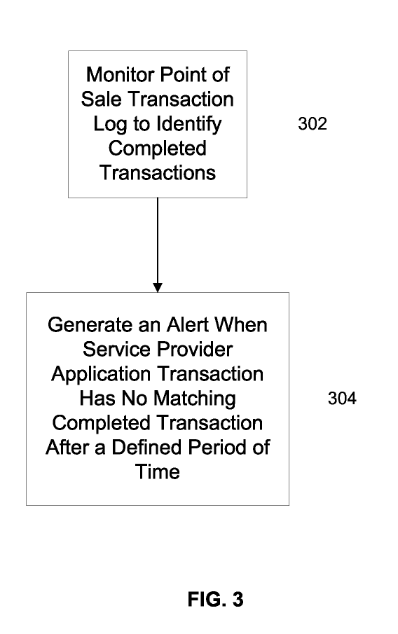

According to another aspect, the method includes monitoring the point of sale transactions, identifying completed transactions 302, transmitting information regarding the completed transactions, and storing the completed transaction information. FIG. 3. In one embodiment, the method includes the POS gateway 108 monitoring the POS transactions 302. The log may reside in a memory of either the POS gateway 108 or the POS server 110, or may reside in a database of either the gateway or server. The POS gateway 108 further identifies completed transactions, and in one embodiment, identifies such transactions by determining the status of entries posted to the POS transaction log. The POS gateway 108 may further transmit the information regarding the completed transaction to a transaction broker 104. In some embodiments, the transaction broker stores the completed transaction information in its memory or a database.

In some embodiments, the status of a service provider transaction is determined and presented; service provider transactions are matched with completed transactions; and alerts and messages are generated when a service provider transaction does not have a matching completed transaction within a defined period of time. For example, those service provider transactions that have matching completed transactions are determined, and those service provider transactions that do not match any completed transactions are identified. According to one embodiment, an alert is generated for a service provider transaction that has no matching completed transaction if a defined period of time has elapsed since the time of a particular event 304. Such events include the time the information regarding service provider transaction was received from the service provider, and the time the service provider transaction information was stored after its receipt. The method includes defining the period of time for a particular type of transaction and location, the period being 1 minute, 3 minutes, 5 minutes, or any other period sufficiently short enough to permit a user to respond to the alert to determine and remedy the non-matching service provider transaction.

In some instances, the alerts may be communicated to a point of sale software, a point of sale terminal, a messaging software, a display monitor, a wireless device, a mobile device, a communication software, a mobile phone, a smartphone, a pager, an e-mail service, an e-mail client, a device that generates sound, a device that generates light, and a device that generates mechanical movement. According to some embodiments, the alert generated may be a message to a software, a message to a mobile device, a message to a wireless device, a message to a telephone, an electronic mail, a sound, a visual stimulus, and a mechanical stimulus. In some examples, the generated alert includes an e-mail message, a pop-up window of a software on a device, a sound on a device, a page to a pager, and a vibration on a device.

According to some embodiments, the method includes retrieving the information regarding service provider transactions, retrieving the information regarding completed transactions, matching service provider transactions with completed transactions, and preparing a reconciliation report. In an example, the method includes the reconciliation application retrieving the information regarding service provider transactions, retrieving the completed transactions information, and matching service provider transactions with completed transactions. The method may further include the reconciliation application generating a point of sale reconciliation report, the report including service provider transactions, point of sale transactions, and uncompleted service provider transactions.

In one embodiment, the method includes managing the mapping of the service provider product codes to the PLUs. The set of products available on a given service provider application is defined by the service provider, and the product codes associated with the products are also defined by the provider. Because, these proprietary product codes normally are not useable as PLUs in the retailer's POS system, the method includes a reconciliation application centrally managing the mapping of product codes with PLUs. This ensures that all service provider transactions that sales associates enter into the point of sale terminals have a consistent product to PLU mapping, reducing errors and inconsistencies, and automates the reconciliation of such transactions.

In some embodiments, the methods may be performed on a plurality of service provide applications, a plurality of transaction brokers, and a plurality of point of sale gateways. For example, in one scenario, the point of sales of two or more retailers are centrally managed, and each of the retailers may operate two or more service provider applications, such as a Western Union application and a lottery application. The method may be performed on transactions among such entities, and permits the alerts and reconciliation reports to be generated centrally.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above systems, constructions, devices, and methods without departing from the scope of aspects of the invention, it is intended that all matter contained in the above description and shown in the accompanying drawings shall be interpreted as illustrative and not in a limiting sense.

1. A method for fraud and reconciliation control in a point of sale system, the method comprising:
receiving information regarding a transaction;
retrieving a price look up code for the transaction information;
creating a suspended point of sale transaction based on the transaction information; and
determining the status of suspended transaction.

2. The method of claim 1 further comprising communicating the status of the suspended transaction to a user.

3. The method of claim 2 further comprising:
providing a service provider application;
providing a transaction broker, the broker including a memory;
generating the information regarding the transaction at the service provider application;
transmitting the transaction information to the broker; and
storing the transaction information in the broker's memory.

4. The method of claim 1 further comprising:
providing a point of sale gateway, the gateway including a memory;
transmitting the transaction information and the code to the gateway;
storing the transaction information and the code in the gateway's memory; and
storing the suspended transaction.

5. The method of claim 4 further comprising:
retrieving the suspended transaction;
presenting the suspended transaction at a point of sale terminal;
processing the suspended transaction; and
transmitting information regarding the suspended transaction to a transaction broker.

6. The method of claim 5 further comprising:
providing a reconciliation application; and
transmitting the suspended transaction information to the reconciliation application;
wherein the reconciliation application is configured to:
determine the status of the suspended transaction;
present the status of the suspended transaction; and
communicate the status of the suspended transaction to a user application.

7. The method of claim 6 wherein the user application is selected from a group comprising: a point of sale software, a point of sale terminal, a messaging software, a display monitor, a wireless device, a mobile device, a communication software, a mobile phone, a smartphone, a pager, an e-mail service, an e-mail client, a device that generates sound, a device that generates light, and a device that generates mechanical movement.

8. The method of claim 6 wherein:
the status of the suspended transaction may be a completed transaction or an uncompleted transaction; and
the reconciliation application is further configured to communicate the status of the suspended transaction only when it is an uncompleted transaction.

9. The method of claim 1 further comprising:
storing the suspended transaction;
retrieving the suspended transaction;
presenting the suspended transaction at a point of sale terminal;
processing the suspended transaction; and
transmitting the status of the suspended transaction to a transaction broker.

10. A method for fraud and reconciliation control in a point of sale system, the method comprising:
receiving information regarding a transaction from a service provider application;
storing the transaction information;
retrieving a price look up code from a database for the transaction;
creating a point of sale transaction comprising the transaction information, the code, and a retrieval number, the point of sale transaction having a status of uncompleted; and
presenting the point of sale transaction at a point of sale terminal.

11. The method of claim 10 further comprising:
providing a point of sale server; the server comprising a memory;
storing the point of sale transaction in the server's memory;
retrieving the point of sale transaction from the server's memory by the point of sale terminal;
completing the point of sale transaction at the point of sale terminal;
updating the status of the point of sale transaction to completed;
monitoring point of sale transactions to identify a completed point of sale transaction; and
presenting the status of the point of sale transaction.

12. The method of claim 10 further comprising:
transmitting the transaction information and the code to a point of sale gateway;
monitoring point of sale transactions to identify a completed point of sale transaction;
notifying a transaction broker of the completed point of sale transaction; and
presenting the status of a point of sale transaction.

13. The method of claim 10 further comprising:
completing the point of sales transaction at the point of sale terminal;
updating the status of the point of sale transaction to completed; and
providing a reconciliation application configured to:
retrieve the status of the point of sale transaction;
present the status of the point of sale transaction; and
communicate the status of the point of sale transaction to a user application.

14. The method of claim 13 wherein the user application is selected from a group comprising: a point of sale software, a point of sale terminal, a messaging software, a display monitor, a wireless device, a mobile device, a communication software, a mobile phone, a smartphone, a pager, an e-mail service, an e-mail client, a device that generates sound, a device that generates light, and a device that generates mechanical movement.

15. An apparatus for fraud and reconciliation control in a point of sale system, the apparatus comprising:
a processor;
a memory in communication with the processor;
wherein the processor is configured to:
receive information regarding a transaction;
receive information regarding completed transactions;
generate an alert when the transaction information does not match any completed transactions.

16. The apparatus of claim 15 wherein the alert is selected from a group comprising: a message to a software, a message to a mobile device, a message to a wireless device, a message to a telephone, an electronic mail, a sound, a visual stimulus, and a mechanical stimulus.

17. The apparatus of claim 15 wherein the processor is further configured to:
store the transaction information in the memory;
retrieve a price look up code for the transaction information;
create a suspended point of sale transaction based on the transaction information and the code;
monitor point of sale transactions for completed transactions; and
post a completed transaction to the transaction log.

18. The apparatus of claim 17 further comprising a service provider application for generating the transaction, wherein:
the information regarding the transaction is generated at the service provider application;
the transaction information is received from the service provider application; and
the processor is further configured to transmit information regarding the suspended transaction to the service provider application.

19. The apparatus of claim 18 wherein the processor is further configured to notify the service provider application of a completed transaction.

20. The apparatus of claim 18 further comprising a point of sale terminal, wherein the suspended transaction information comprises a retrieval number corresponding to the suspended transaction, and the point of sale terminal is configured to retrieve the suspended transaction based on the retrieval number.

21. The apparatus of claim 17 further comprising a reconciliation application, wherein
the processor is further configured to:
store the transaction information; and
store the completed transactions information; and
the reconciliation application is configured to
retrieve the transaction information and the completed transactions information; and
generate the alert.

22. The apparatus of claim 21 wherein the alert is generated if the transaction information does not match any completed transactions after a defined period of time has elapsed.

23. The apparatus of claim 21 wherein the reconciliation application is further configured to:
match the transaction information with the completed transactions information; and
generate a reconciliation report, the report comprising each transaction information and the completed transactions information.

24. An apparatus for fraud and reconciliation control in a point of sale system, the apparatus comprising:
at least one processor;
at least one memory in communication with each processor;
a transaction broker configured to:
receive, from a service provider application, information regarding a transaction;
store the transaction information;
retrieve a price look up code for the transaction information;
transmit the transaction information and the code to a point of sale gateway;
transmit the transaction information and the code to a reconciliation application;
receive information regarding a suspended transaction from the point of sale gateway;
transmit the suspended transaction information to the service provider application;
receive information regarding a completed transaction from the point of sale gateway;
transmit the completed transaction information to the reconciliation application;
transmit an indication of a store close record to the service provider application; and
transmit the store close record indication to the reconciliation application;
wherein the point of sale gateway is configured to:
receive the transaction information and the code from the broker;
create a suspended point of sale transaction based on the transaction information and the code, the suspended transaction information including a retrieval number;
transmit information regarding the suspended transaction to the broker;
store the suspended transaction;
monitor point of sale transactions for completed transactions;
monitor point of sale transactions for the store close record indication;
transmit information regarding completed transactions to the transaction broker; and
transmit the store close record indication to the broker; and
a point of sale terminal configured to:
retrieve the suspended point of sale transaction; and
post a completed transaction to the transaction log;
wherein the reconciliation application is configured to:
receive transaction information and completed transaction information from a broker;
match transaction information with completed transactions;
generate an alert for each transaction information that, after a defined period of time, does not have a matching completed transaction; and
generate a reconciliation report comprising each transaction information and each completed transaction.

25. The apparatus of claim 24 further comprising:
a plurality of service provider applications;
a plurality of transaction brokers; and
a plurality of point of sale gateways.
